(19) United States
(12) Patent Application Publication
(10) Pub. No.: US 2012/0053884 A1
(43) Pub. Date: Mar. 1, 2012

(54) STANDBY GENERATOR WITH WEATHER ALERT RECEIVER AND METHOD OF OPERATION

(75) Inventors: Brandon M. Batzler, Hartford, WI (US); Kenny J. Stair, North Prairie, WI (US); Sie Teong Lim, Brookfield, WI (US); Michael F. Gersmeyer, Menomonee Falls, WI (US); Michael Miller, Sussex, WI (US); Dean L. Weigand, Waukesha, WI (US)

(73) Assignee: BRIGGS & STRATTON CORPORATION, Wauwatosa, WI (US)

(21) Appl. No.: 12/872,618

(22) Filed: Aug. 31, 2010

(51) Int. Cl. H02J 9/08

(52) U.S. Cl. 702/122

(57) ABSTRACT

A standby generator including a weather alert receiver and a method of testing said standby generator. The method includes receiving any one of a plurality of weather alerts, determining if the received weather alert exceeds a priority level, determining a period of time in which the standby generator was last run in an exercise mode, and if the weather alert exceeds the priority level and if the period of time is above a testing threshold, automatically starting the generator and running it in an exercise mode. The control unit of the generator monitors for any one of a plurality of generator fault conditions, and provides an indication on a control panel of a detected generator fault condition. Both weather alert information and generator fault condition information can be relayed to a remote status display device.

### BACKGROUND OF THE INVENTION

The present disclosure generally relates to a system and method for testing the status of a standby generator. More specifically, the present disclosure relates to a system and method for testing a standby generator by automatically starting the standby generator upon receipt of a weather alert, monitoring for any one of a plurality of generator fault conditions, and providing an indication of a detected generator fault condition.

Power outages are often caused by severe weather events. When there is a power outage, backup power may be provided by a standby generator. Currently, standby generator systems exist in which the standby generator is set to start up and run in an exercise mode on a recurring basis, for example, every fifteen days. However, if it has been a number of days since the standby generator was last run in the exercise mode, and if a severe weather event is approaching, it is desirable to test the standby generator to make sure the generator is in good working condition before the weather event occurs in the geographic area in which the residence is located and served by the generator. Such testing would be useful to insure that the generator has not suffered a fault condition in the time period between the last self-testing and the approaching weather event.

Weather alert receivers are well known in the prior art. For example, the National Weather Radio Specific Area Message Encoding (NWR SAME) receiver receives information broadcasted by the National Weather Service including the type of weather event, the geographical area affected, and the expiration time of the weather alert. SAME receivers allow the owner/operator to choose what type of weather event he wishes to receive alerts for. SAME receivers also allow the owner/operator to choose the geographical area for which he desires to receive weather alerts. The weather alert receiver receives and decodes information about the severity of the weather event (i.e., whether it is a warning, watch or emergency) and the type of weather event (i.e., whether it is a tornado, severe thunderstorm, flash flood, or any other type of weather event). More specific information is available in National Weather Service Instruction 10-1712, Feb. 12, 2007, available at http://www.nws.noaa.gov/directives/.

### SUMMARY OF THE INVENTION

The present disclosure relates to a system and method for testing a standby generator upon receipt of a weather alert. The system includes a standby generator for providing electrical power to a power distribution network. A control unit is contained within the standby generator. The control unit monitors the status of the standby generator and generates error codes upon detection of any one of a plurality of generator fault conditions. These generator fault conditions can be displayed on a control panel of the control unit, and/or can be relayed to a remote status display device. The system further includes a weather alert receiver. The weather alert receiver receives weather alert signals and relays weather alert information to the control unit within the standby generator. This weather alert information can also be displayed on the control panel of the control unit, and/or can be relayed to the remote status display device.

The present disclosure also includes a method of testing a standby generator. According to the method, the standby generator includes a weather alert receiver that receives any one of a plurality of weather alerts. The standby generator automatically starts upon receipt of a weather alert for the geographic area in which the generator is located. The standby generator is monitored for any one of a plurality of generator fault conditions, and if such a generator fault condition is detected, the standby generator shuts down and provides an indication of the detected generator fault condition.

The method further includes, if so desired, starting the standby generator only when the received weather alert exceeds a user-defined priority level. Also, if so desired, the method further includes running the standby generator in an exercise mode after automatically starting the standby generator upon receiving the weather alert. It is also possible to determine the period of time since the standby generator was last run in the exercise mode, and if the period of time is below a testing threshold, to prevent the standby generator from automatically starting and running in the exercise mode upon receipt of the weather alert. Finally, the method may include displaying error codes and/or weather alert information on the control panel of the control unit, and/or transmitting the weather alert information to a remote status display device.

Various other features, objects, and advantages of the disclosure will be made apparent from the following description taken together with the drawings.

### BRIEF DESCRIPTION OF THE DRAWINGS

The drawings illustrate the best mode presently contemplated of carrying out the disclosure. In the drawings:

FIG. 1 is a perspective view of a standby generator;

FIG. 2 is a perspective view of a control panel of the standby generator;

FIG. 3 is a schematic illustration of a weather alert receiver, a standby generator comprising a control unit and a transmitter, and a remote status display device;

FIG. 4 is a perspective view of one embodiment of the remote status display device; and

FIG. 5 is a flowchart exemplifying a method of operating the standby generator according to the present disclosure.

### DETAILED DESCRIPTION OF THE INVENTION

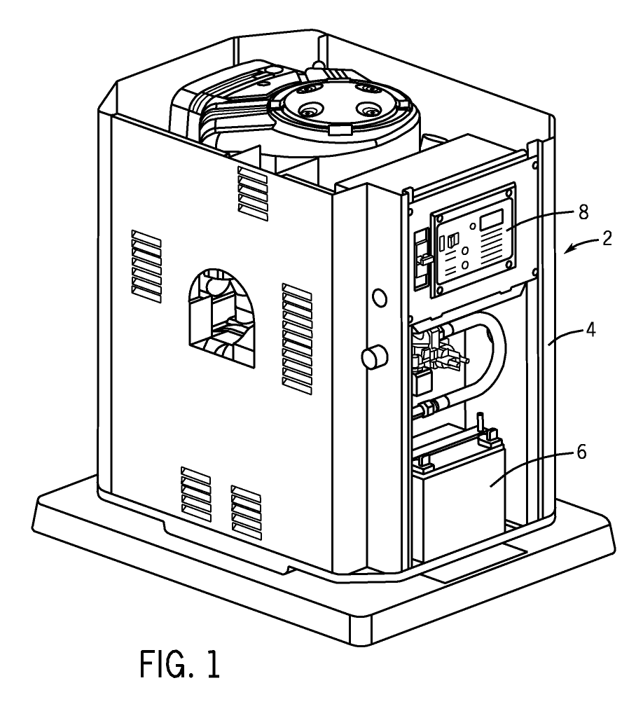

FIG. 1 illustrates one embodiment of a standby generator 2 that can be utilized with the present disclosure. In the exemplary embodiment shown, the standby generator 2 is a 10 kilowatt home generator system, although other standby generators could be utilized. The standby generator 2 includes an internal combustion engine that can be operated by using various types of fuel, such as but not limited to gasoline, diesel, natural gas or liquid propane.

As illustrated in FIG. 1, the standby generator 2 includes an outer housing 4 that encloses the operating components of the standby generator 2, including a 12-volt DC battery 6. The battery 6 provides the required power to start the internal combustion engine.

The standby generator 2 includes a control panel 8 that allows an operator to conduct various tests, monitor the operation of the standby generator 2, and perform various maintenance functions for the standby generator 2. The control panel 8 is connected to a control unit for the standby generator 2 such that the control unit can relay messages to an owner/operator and receive input commands through the control panel 8.

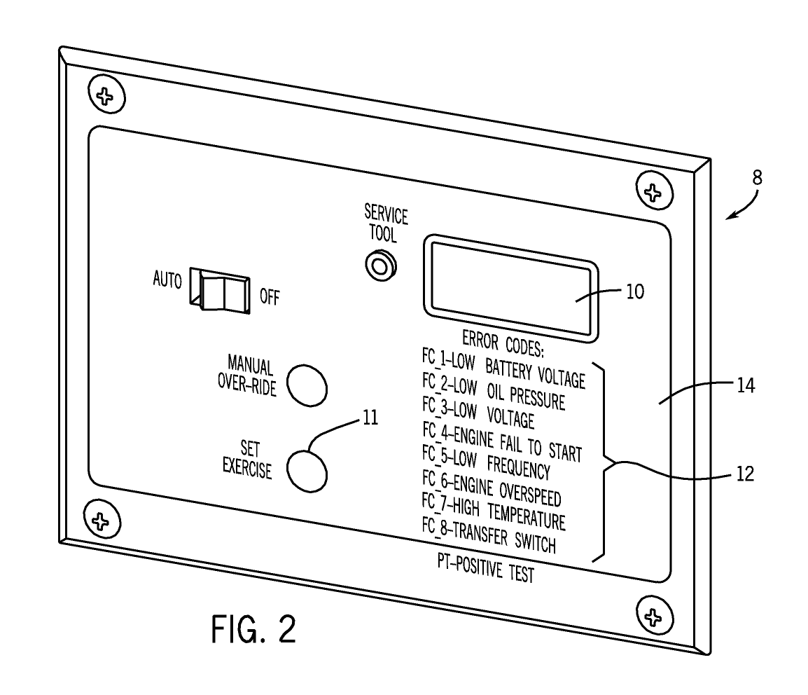

FIG. 2 is a magnified view of the control panel 8. The control panel 8 includes a digital display 10 that allows the control unit of the standby generator to display the total number of hours the standby generator has been running and various error codes. The digital display 10 is also used to schedule maintenance tasks and for troubleshooting operational problems within the standby generator. One example of a maintenance task that can be scheduled through the control panel 8 is when the generator is scheduled to start and run in an exercise mode. In this example, the owner/operator could use the control panel 8 to set the standby generator 2 to run in the exercise mode every certain number of days by pressing the “set exercise” button 11 on the control panel and adjusting the testing threshold to, for example, fifteen days.

The standby generator 2 is preferably set to shut down if a fault condition is detected while the standby generator is run in the exercise mode. As can be understood in FIGS. 1 and 2, the control panel 8 including the digital display 10 allows an owner/operator to determine the type of fault condition that caused the standby generator to shut down when the owner/operator is present at the standby generator. A list of error codes, referred to by reference numeral 12, is printed on the face surface 14 of the control panel 8 such that the owner/operator can determine the type of fault condition, if any, that has occurred within the standby generator 2 based upon the error code shown on the digital display 10. The digital display 10 of the control panel 8 can also be configured to display other information or messages, such as weather alert information.

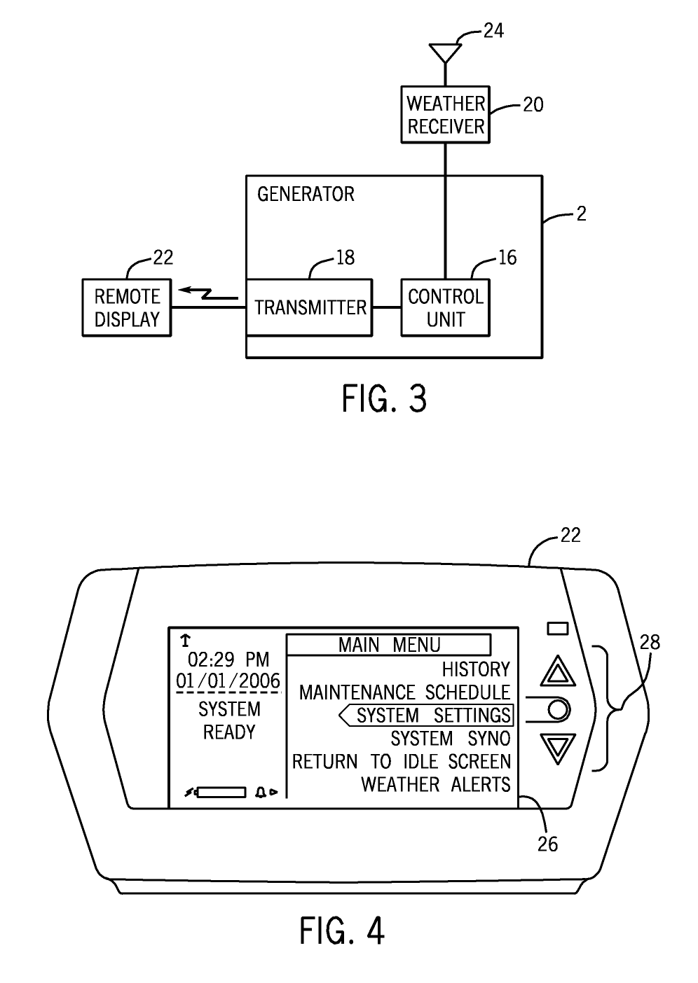

FIG. 3 schematically illustrates the standby generator 2, comprising a control unit 16, a transmitter 18, a weather alert receiver 20 and a remote status display device 22. The weather alert receiver 20 may include an antenna 24. Preferably, the weather alert receiver 20 is a NWR SAME receiver set to pick up National Weather Service alert frequencies.

The weather alert receiver 20 receives weather alerts broadcast by the National Weather Service, as described above. The weather alert receiver 20 relays this weather alert information to the control unit 16. In one embodiment, the weather alert receiver 20 can be formed as a part of the control unit 16. In an alternate embodiment, the weather alert receiver 20 can be formed separate from the control unit 16.

The standby generator 2 also includes a transmitter 18 that relays the error codes and the weather alert information to the remote status display device 22. The transmitter 18 can be configured to transmit information to the remote display device 22 using various different types of communication techniques. As one example, the transmitter 18 can be a wireless communication device and information is then relayed from the transmitter 18 to the remote display device 22 utilizing wireless communications. Alternatively, the transmitter 18 can be configured to relay information to the remote display device 22 utilizing power line carrier (PLC) communication techniques. In such an embodiment, the transmitter 18 would communicate with the remote status display device 22 utilizing messages carried over the electrical wiring of the residence service by the standby generator 2. Other types of communication techniques are also contemplated as being within the scope of the present disclosure. In one embodiment, the transmitter 18 is part of the control unit 16. In an alternate embodiment, the transmitter 18 is separate from the control unit 16.

Referring now to FIG. 4, thereshown is one exemplary embodiment of the remote status display device 22. The remote status display device 22 includes a digital display 26. The remote status display device 22 further includes a user input device 28 that allows the owner/operator to control the display 26. In this manner, the owner/operator can view the type of weather alert, the maintenance schedule, the last date that the generator was tested, or the error code issued by the generator, among other things. As can be understood in FIGS. 3 and 4, the remote status display device 22 including the digital display 26 allows an owner/operator to determine the type of fault condition that caused the standby generator to shut down when the owner/operator is present at the remote status display device 22. The owner/operator can also view the weather alert information at the remote status display device 22 as will be described below.

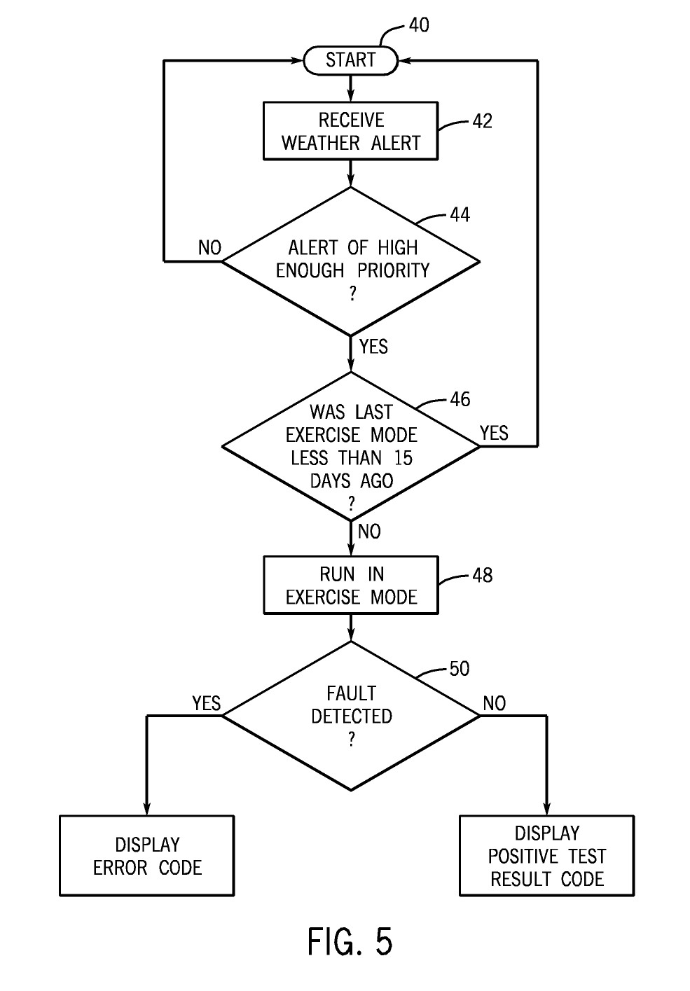

Referring now to FIG. 5, thereshown is an exemplary embodiment of a method of operating and testing the standby generator 2. The method begins at step 40, with the standby generator 2 off and the weather alert receiver 20 in a mode that allows it to receive a weather alert from the National Weather Service. At step 42 the weather alert receiver receives the weather alert. If the weather alert receiver 20 is not part of the control unit 16, the weather alert information is then relayed to the control unit 16. If the weather alert receiver is part of the control unit 16, then the weather alert information need not be relayed.

At step 44, the control unit 16 determines if the weather alert is of high enough priority that the standby generator 2 needs to be started and tested. This priority level can be defined by the owner/operator of the standby generator. For example, if the owner/operator wishes only to test the standby generator when a tornado is in the area, the operator may program the control unit 16 such that it only starts the standby generator 2 when such a weather alert is received. On the other hand, if the owner/operator does not wish to start the standby generator 2 if a weather alert of a thunderstorm is received, the owner/operator could also program this instruction into the control unit 16. As described previously, the owner of the standby generator can enter the priority level information into the standby generator through the control panel 8 mounted to the standby generator (see FIG. 2). Referring back to FIG. 5, if the weather alert is not of high enough priority at step 44, the process returns to START at step 40, wherein the standby generator 2 is off and the weather alert receiver 20 is in the mode in which it monitors for weather alerts from the National Weather Service.

If the alert is of high enough priority at step 44, the process can then move to step 46 where the control unit 16 determines when the generator was last tested in the exercise mode. As described previously, the owner of the standby generator can select the time interval between testing the generator by running the generator in the exercise mode. The default time period included in the control unit of the generator is thirty days. However, this interval could be reduced depending upon the requirements of the owner. In step 46, the method determines when the generator was last tested by operating the generator in the exercise mode. In a configuration in which the generator is operated in the exercise mode every thirty days, the method utilizes a fifteen-day threshold, as illustrated in step 46. Although the method shown in FIG. 5 uses a fifteen-day period between test of the standby generator by running the standby generator in exercise mode, it should be understood that many different testing thresholds could be programmed into the control unit 16 at which the control unit 16 would run the generator 2 in an exercise mode. In the embodiment shown in FIG. 5, if the exercise mode was run less than fifteen days ago, the control unit 16 returns to step 40, where the standby generator 2 is off and where the weather alert receiver 20 monitors for weather alerts. On the other hand, if the last exercise mode was more than fifteen days ago, the standby generator 2 is then run in the exercise mode in step 48. The fifteen-day threshold utilized in step 46 prevents the generator from running in the exercise mode if the generator was run in the exercise mode a short time ago. If the generator was not run in the exercise mode within the last fifteen days, which is half of the testing cycle, the method runs the generator in the exercise mode to determine if any fault conditions exist.

In the exercise mode in step 48, the standby generator 2 runs to test for any one of a plurality of generator fault conditions. If one of such generator fault conditions is detected, at step 50, the control unit 16 displays an error code (such as shown in list 12) on the digital display 10 of the control panel 8. If none of the fault conditions are detected, the digital display 10 shows a positive test result code.

In this manner, the owner/operator is alerted as to whether or not the standby generator is operating under faulty conditions before a weather event actually reaches his residence and possibly disrupts transmission of power from utility lines to his residence. This gives the owner/operator time to service the standby generator himself or to contact a professional to service the generator for him.

The error codes, positive test result codes, and weather alert information can all then be relayed to the remote status display device 22 via the transmitter 18, as shown in FIG. 3. It is to be understood that even if the standby generator was run in the exercise mode recently (for example, less than fifteen days ago as in step 46) and thus it is not necessary to run the standby generator in an exercise mode once again, the transmitter 18 may still be configured to relay weather alert information to the remote status display device 22.

In an exemplary embodiment, the control unit 16 transmits a signal to the remote status display device 22 to convey information on the weather alert and the generator fault condition. The control unit 16 can do so through the use of the transmitter 18, the transmitter 18 being either internal or external to the control unit 16 as described above. The remote status display device 22 may display the weather alert information, such as the type of weather event, the severity of the weather event, and the time at which the weather alert is no longer in effect. The remote status display device 22 may also display the error code that corresponds to the detected generator fault condition. Finally, the remote status display device 22 may emit an audible alarm to alert the owner/operator that the standby generator 2 has encountered a fault condition, or that there is a weather alert for his geographical area. This audible alarm may be something as simple as a beeping noise, or may include a vocal description of the weather alert information, and/or the error code information.

We claim:

1. A method of testing a standby generator, comprising:
receiving any one of a plurality of weather alerts;
automatically starting the standby generator upon receipt of the weather alert;
monitoring for any one of a plurality of generator fault conditions; and
providing an indication of a detected generator fault condition.

2. The method of claim 1, wherein the standby generator is automatically started only when the received weather alert exceeds a priority level.

3. The method of claim 2, further comprising the step of allowing an operator to define the priority level of the weather alert at which the standby generator starts.

4. The method of claim 1, further comprising the step of running the standby generator in an exercise mode after automatically starting the standby generator upon receipt of the weather alert.

5. The method of claim 4, further comprising the steps of:
determining a period of time since the standby generator was last run in the exercise mode; and
if the period of time is below a testing threshold, preventing the standby generator from automatically starting upon receipt of the weather alert.

6. The method of claim 1, further comprising the step of displaying an error code upon detection of any of the plurality of generator fault conditions.

7. The method of claim 6, further comprising the step of sending the error code to a remote status display device.

8. The method of claim 1, further comprising the step of displaying weather alert information based on the received weather alert.

9. The method of claim 8, further comprising the step of transmitting the weather alert information to a remote status display device and displaying the weather alert information on the remote status display device.

10. The method of claim 9, wherein the weather alert information includes a type of weather event, a time when the weather alert expires, and severity of the weather event.

11. The method of claim 9, wherein the remote status display device emits an audible alarm.

12. A standby generator for providing electrical power to a power distribution network, the standby generator comprising:
a control unit contained within the standby generator for monitoring the status of the standby generator and generating error codes upon detection of fault conditions; and
a weather alert receiver for receiving weather alert signals and relaying weather alert information to the control unit.

13. The generator of claim 12, wherein the weather alert receiver is contained within the control unit.

14. The generator of claim 12, wherein the standby generator includes a transmitter to relay the weather alert information and the error codes to a remote status display device.

15. The generator of claim 14, wherein the transmitter is contained within the control unit.

16. The generator of claim 14, wherein the remote status display device receives and displays the weather alert information and the error codes.

17. The generator of claim 14, wherein the remote status display device emits an audible alarm upon receipt of one of the weather alert information and the error codes.

18. A method of testing a standby generator, comprising:
receiving any one of a plurality of weather alerts;
determining if the received weather alert exceeds a priority level;
determining a period of time since the standby generator was last run in an exercise mode;
automatically starting the standby generator if the weather alert exceeds the priority level and if the period of time is above a testing threshold;
running the standby generator in the exercise mode;
monitoring for any one of a plurality of generator fault conditions; and
providing an indication of a detected generator fault condition.

19. The method of claim 18, further comprising the step of allowing an operator to define the priority level of the weather alert at which the standby generator starts.

20. The method of claim 18, further comprising the step of displaying an error code upon detection of any of the plurality of generator fault conditions.
